(19) United States
(12) Patent Application Publication
(10) Pub. No.: US 2008/0151418 A1
(43) Pub. Date: Jun. 26, 2008

(54) Tradeoff between reliability and performance for a disk drive

(76) Inventors: Paul Cisewski, Morgan Hill, CA (US); Ryohheita Hattori, San Jose, CA (US); Kris Schouterden, San Jose, CA (US); Jerome Venneman, San Jose, CA (US)

Correspondence Address: HITACHI C/O WAGNER BLECHER LLP, 123 WESTRIDGE DRIVE, WATSONVILLE, CA, 95076, US

(21) Appl. No.: 11/643,154

(22) Filed: Dec. 20, 2006

(51) Int. Cl. G11B 5/52

(52) U.S. Cl. 360/86

(57) ABSTRACT

Embodiments of the present invention pertain to a tradeoff between reliability and performance for a disk drive. According to one embodiment, a first measurement at a first thermal fly height control (TFC) heater level that provides low reliability for a parameter and a second measurement at a second TFC heater level that provides low performance for the parameter are determined. The first measurement and the second measurement are used to determine if there is a third TFC heater level that at least satisfies a criteria for the parameter whereby the tradeoff between the reliability and the performance for the disk drive is enabled.

### TECHNICAL FIELD

Embodiments of the present invention relate to disk drives. More specifically, embodiments of the present invention relate to enabling a tradeoff between reliability and performance for a disk drive.

### BACKGROUND

Manufacturing disk drives is a very competitive business. People that buy disk drives are demanding more and more for their money. For example, they want disk drives that are more reliable and are able to store more data.

Typically a hard disk drive (HDD) uses an actuator assembly for positioning read write heads at the desired location of a disk to read data from and/or write data to the disk. The read write heads can be mounted on what is known as a slider. Generally, a slider provides mechanical support for a read write head and electrical connections between the head and the drive. Typically, the closer that the slider can glide over a disk's surface the higher the density that data can be stored on the disk's surface.

The rotation of a disk around the spindle causes air to move beneath a slider. The slider can glide over the moving air at a uniform distance above the surface of the rotating disk, thus, generally avoiding contact between the read write head and the surface of the disk. However, the closer that a slider glides over the disk's surface, the higher the probably that the slider will contact the disk in the event of turbulence, a particle coming between the slider and the disk's surface, or due to unevenness in the disk's surface.

### SUMMARY OF THE INVENTION

Embodiments of the present invention pertain to a tradeoff between reliability and performance for a disk drive. According to one embodiment, a first measurement at a first thermal fly height control (TFC) heater level that provides low reliability for a parameter and a second measurement at a second TFC heater level that provides low performance for the parameter are determined. The first measurement and the second measurement are used to determine if there is a third TFC heater level that at least satisfies a criteria for the parameter whereby the tradeoff between the reliability and the performance for the disk drive is enabled.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 depicts a plan view of a disk drive for facilitating the discussion of various embodiments of the present invention.

FIG. 2 depicts a side view of a read write head that is flying over a disk's surface, according to one embodiment.

FIGS. 3-5 depict graphs that result from enabling a tradeoff between reliability and performance for a disk drive, according to various embodiments.

FIG. 6 depicts an apparatus for enabling a tradeoff between reliability and performance for a disk drive, according to one embodiment.

FIG. 7 depicts a flowchart of a method for enabling a tradeoff between reliability and performance for a disk drive, according to one embodiment.

The drawings referred to in this description should not be understood as being drawn to scale except if specifically noted.

### DETAILED DESCRIPTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

### Overview

In general, the closer that a read write head flies over a disk's surface, the easier it is for the head to write data to the disk's surface and the easier it is for the head to read data from the disk's surface. However, the closer the read write head flies over the disk's surface, the higher the probability that the read write head will come into contact with the disk's surface, which could result in a loss of data or damage to the disk's surface or a combination thereof. Therefore, low fly heights provide higher performance but lower reliability and high fly heights provide lower performance but higher reliability. According to one embodiment, a tradeoff between reliability and performance for a disk drive is provided.

### A Disk Drive

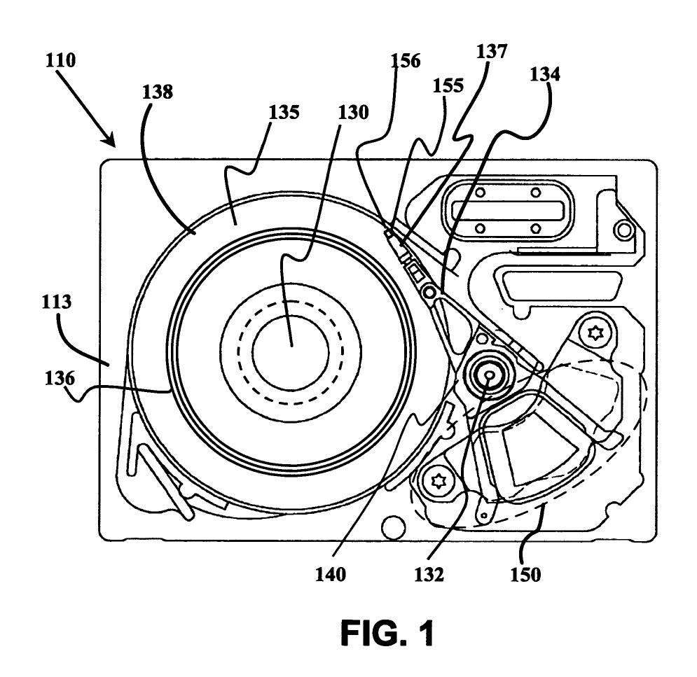

FIG. 1 depicts a plan view of a disk drive for facilitating the discussion of various embodiments of the present invention. The disk drive 110 includes a base casting 113, a motor hub assembly 130, a disk 138, actuator shaft 132, actuator arm 134, suspension assembly 137, a hub 140, voice coil motor 150, a magnetic head 156, and a slider 155.

The components are assembled into a base casting 113, which provides attachment and registration points for components and sub assemblies. A plurality of suspension assemblies 137 (one shown) can be attached to the actuator arms 134 (one shown) in the form of a comb. A plurality of transducer heads or sliders 155 (one shown) can be attached respectively to the suspension assemblies 137. Sliders 155 are located proximate to the disk 138's surface 135 for reading and writing data with magnetic heads 156 (one shown). The rotary voice coil motor 150 rotates actuator arms 135 about the actuator shaft 132 in order to move the suspension assemblies 150 to the desired radial position on a disk 138. The actuator shaft 132, hub 140, actuator arms 134, and voice coil motor 150 may be referred to collectively as a rotary actuator assembly.

Data is recorded onto the disk's surface 135 in a pattern of concentric rings known as data tracks 136. The disk's surface 135 is spun at high speed by means of a motor-hub assembly 130. Data tracks 136 are recorded onto spinning disk surfaces 135 by means of magnetic heads 156, which typically reside at the end of sliders 155.

FIG. 1 being a plan view shows only one head, slider and disk surface combination. One skilled in the art understands that what is described for one head-disk combination applies to multiple head-disk combinations, such as disk stacks (not shown). However, for purposes of brevity and clarity, FIG. 1 only shows one head and one disk surface.

### TFC Heater

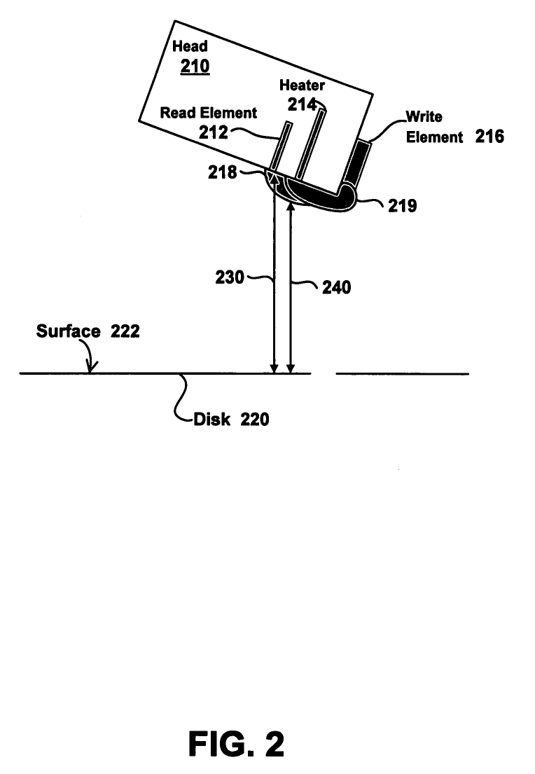

FIG. 2 depicts a side view of a read write head 210 that is flying over a disk 220's surface 222, according to one embodiment. The head 210 includes a thermal fly height control (TFC) heater 214, a read element 212 and a write element 216. Some materials associated with a read write head 210 have properties that cause them to expand, for example, when those materials are heated. Heat from the TFC heater 214, the write element 216, among other things, can cause these types of materials to expand. The expanded material is also commonly known as a “protrusion.” FIG. 2 depicts two protrusions 218 and 219. Protrusion 218 is generated due to heat from the TFC heater 214 and protrusion 219 is generated mainly due to heat from the write element 216. The size of a protrusion 218, 219 typically increases when the heat increases and decreases when the heat decreases.

A protrusion can cause the read write head to fly closer to the disk's surface. The larger the protrusion, the closer the read write head will be to the disk's surface. The TFC heater can be turned on and off so that it is generating heat in certain situations and not generating heat in other situations. For example, the TFC heater may be turned on during a read operation in order to fly closer to the disk's surface while reading. Fly height 230 represents the fly height during a read operation if the TFC heater 214 is not on. Fly height 240 represents the fly height during a read operation if the TFC heater 214 is turned on.

Further, the TFC heater can be adjusted to generate different amounts of heat. For example, the TFC heater may be turned on at the beginning of a write operation but as heat is generated by the write element the amount of heat generated by the TFC heater can be lessened in order to achieve a relatively constant fly height through out the write operation.

### Parameter

Various embodiments can be used with any disk drive parameter that affect or can be affected by reliability, performance, or a combination thereof. Examples of parameters include soft error rate (SER), over write (OW), old information (OI), and magnetic core width (MCW). Measurements of OI reflect how far the head can be offset from track center and still be able to read the data.

Measurements of SER can reflect, among other things, how well a read write head is reading or writing data to a disk. For example, poor SER correlates to a high fly height, which makes it more difficult to read and write data (low performance). Good SER correlates to a low fly height, which makes it easier to read and write data (high performance). A high fly height correlates to high reliability and low performance. A low fly height correlates to low reliability and high performance. In another example, a large MCW measurement correlates to a low fly height. A small MCW measurement correlates to a higher fly height.

Although many embodiments are illustrated in terms of SER, OW, OI, or MCW, various embodiments can be used with any parameter that can affect or can be affected by reliability, performance, or a combination thereof.

### Criteria

Typically, manufacturers of disk drives have determined minimum standards for example through various experimentations or testing that they want the various parameters to meet. These minimum standards can be achieved by satisfying “criteria.” Typically there are criteria on a per parameter basis. The notation SERc shall refer to criteria for the SER parameter, OWc shall refer to criteria for the OW parameter, OIc shall refer to criteria for the OI parameter, and MCWc shall refer to criteria for the MCW parameter.

### TFC Heater Levels and Measurements

The TFC levels (also referred to as “heater levels” or just as “levels”) can be determined through a disk drive's operations, for example, while the disk drive is being manufactured or under normal operating conditions. The relationship between heater level and protrusion can be characterized using a small population of HDDs and then applied to the larger population.

The TFC heater can be used to cause the slider to fly lower and lower until the slider touches the disk's surface. Touching a disk's surface is an example of unacceptable reliability. The event of the slider touching the disk's surface can be used to determine the first level, which provides low reliability. However, any level that results in low reliability can be used as the first level.

The TFC heater can be used to cause the slider to fly higher and higher until the SER moves from satisfactory performance to unsatisfactory performance. A level that resulted in the transition from satisfactory performance to unsatisfactory performance can be used as the second level. A level that was used before transitioning from satisfactory performance to unsatisfactory performance can be used as the second level. A level that provides satisfactory performance that is in proximity to a level that provides unsatisfactory performance can be used. The other direction can also be used. For example, the TFC heater can be used to cause the slider to start flying at a fly height that provides unsatisfactory performance and then move down until satisfactory performance is detected. Any level that results in low performance can be used as the second level.

The levels can be determined in the reverse order as well. For example, the level that provides low performance can be determined first. Then the slider can be lowered, for example, a little at a time to determine the level that provides low reliability.

The levels can be determined based on results that were obtained through previous experimentation, according to another embodiment. For example, many manufacturers have specifications that document levels that provide various degrees of reliability or performance.

According to various embodiments, levels can be obtained for each head associated with a disk drive. For example, assume a disk drive has two heads 1 and 2. Level A that provides low reliability and level B that provides low performance can be determined for head 1. Further, level C that provides low reliability and level D that provides low performance can be determined for head 2. Levels can be obtained for various portions of a disk, such as each zone, in a similar manner. Levels can be obtained for each head to zone combination.

Measurements for a parameter can be taken at the levels that provide low reliability and low performance. For example, a measurement for SER can be taken at the level that provides low reliability and another measurement for SER can be taken at the level that provides low performance. The measurements based on the levels can be determined in any order. For example, a measurement at a level that provides low reliability for a parameter can be determined then a measurement at a level that provides low performance for the measurement can be determined or vice versa.

One factor in selecting the levels may be to provide a relatively linear function based on the levels. For example, measurements for a function may be unreliable for levels below a certain point or above a certain point. Therefore, according to one embodiment, the levels for measuring a parameter for low reliability and low performance are selected to provide a relatively linear function based on the levels, as will become more evident.

### Function

A function, such as fSER(p), fMCW(p), fOW(p), and fOI(p), is based on measurements at the first level and the second level for the corresponding parameter SER, MCW, OW, or OI. The functions may be based on measurements taken at additional levels besides the first level and the second level. According to one embodiment, the function is linear or approximately linear. According to another embodiment, the function is non-linear.

### A Single Parameter

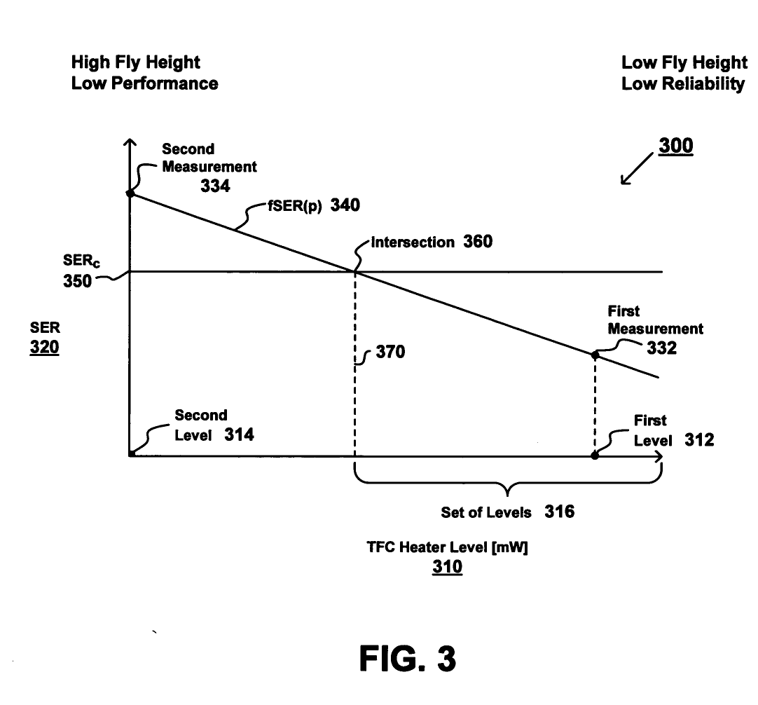

FIG. 3 depicts a graph that results from using a method of enabling a tradeoff between reliability and performance for a disk drive, according to one embodiment. The x-axis 310 represents TFC heater levels measured in milliwatts (mW). The y-axis 320 represents measurements of soft error rates (SERs). SER is an example of a parameter. The first level 312 represents a TFC heater level that provides low reliability for SER. The y-axis 320 as depicted in FIG. 3 line up with the second level 314, which may not be a value of zero. The second level 314 represents a TFC heater level that provides low performance for SER.

fSER(p) 340 is a function based on the measurements 334 and 332 taken at the first and second levels. SERc 350 represents a criteria for the parameter SER. The function 340 (fSER(p)) and the criteria 350 (SERC) intersect at point 360. The set of levels 316 that satisfy the criteria 350 for SER are located at or to the right of the dotted line 370. The set of levels 316 was determined based on the measurements 332 and 334. A third TFC heater level can be selected from the set of levels 316 and used to adjust a TFC heater in order to provide a tradeoff between reliability and performance.

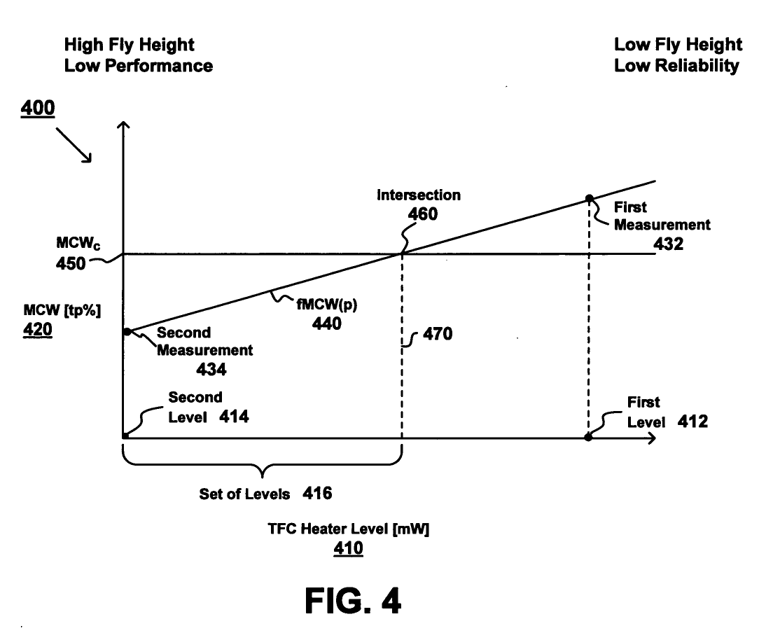

FIG. 4 depicts a graph 400 that results from using a method of enabling a tradeoff between reliability and performance for a disk drive, according to another embodiment. The x-axis 410 represents TFC heater levels measured in mW. The y-axis 420 represents measurements of magnetic core width (MCW). MCW is an example of a parameter. The first level 412 represents a TFC heater level that provides low reliability for MCW. The second level 414 represents a TFC heater level that provides low performance for MCW. In a similar manner to FIG. 3, FIG. 4 depicts measurements 432 and 434 taken respectively at the first level 412 and the second level 414, a function 440 based on the measurements 432 and 434, criteria 450, an intersection 460 between the function 440 and the criteria 450, and a set 416 that satisfies the criteria 450, among other things. However, FIG. 4 pertains to MCW instead of SER. In this case, the set of levels 416 that satisfy the criteria 450 includes the levels at and to the left of the dotted line 470.

### More than One Parameter

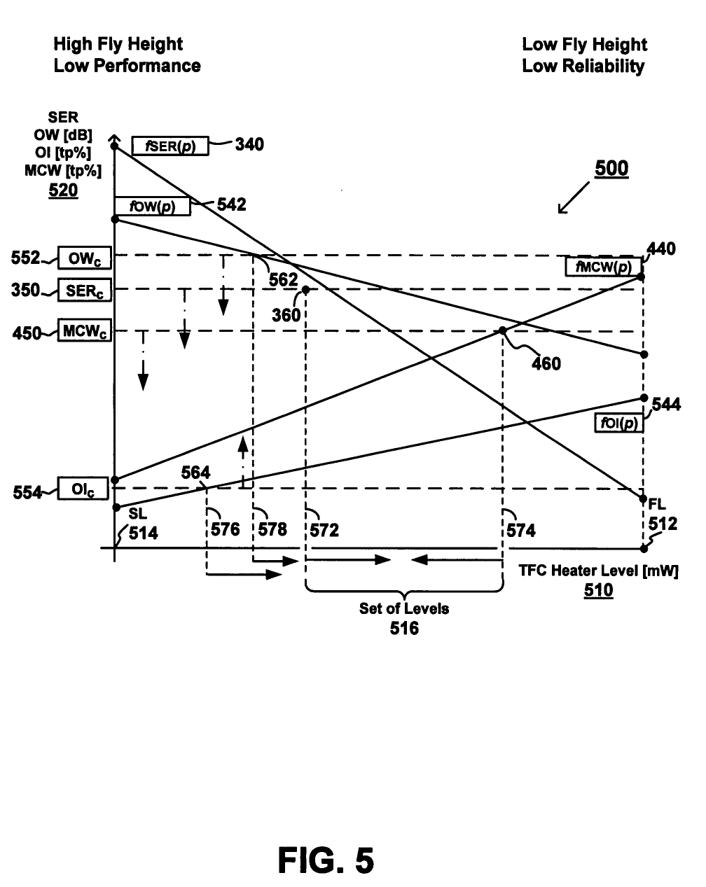

FIG. 5 depicts a graph 500 that results from using a method of enabling a tradeoff between reliability and performance for a disk drive, according to yet another embodiment. The x-axis 510 represents TFC heater levels measured in mW. The y-axis 520 represents measurements of the parameters SER, OW, OI, and MCW. The graph 500 depicts dots to the right which represent the first set of measurements taken at the first level 512 for the corresponding parameters. The graph 500 also depicts dots along the y axis 520 which represent the second set of measurements taken at the second level 514 for the corresponding parameters.

As depicted in FIG. 5, a first set of measurements for the functions 340, 440, 542, and 544 were all taken at the same level 512 and a second set of measurements for the functions 340, 440, 542, and 544 were all taken at the same level 514. However, the first set of measurements for the functions 340, 440, 542, and 544 may be taken at different levels that provide low reliability. Further, the second set of measurements for the functions 340, 440, 542, and 544 may be taken at different levels that provide low performance.

FIG. 5 also depicts functions 340, 440, 542, and 544, criteria 350, 450, 552, 554, intersections 360, 460, 562, 564, and a set that satisfies the criteria for the parameters. The functions 340, 440, 542, and 544 depicted in FIG. 5 include fSER(p), fOW(p), fMCW(p), fOI(p) which are based on the respective first measurements and second measurements. The criteria 350, 450, 552, 554 include OWc, SERc, MCWc, and OIc. The intersections based on the functions 340, 440, 542, and 544 and the criteria 350, 450, 552, 554 are represented by the intersections 360, 460, 562, 564.

The set of levels 516 that satisfies the criteria 350, 450, 552, 554 includes levels that satisfy the criteria for all of the parameters SER, MCW, OI, OW depicted in FIG. 5. For example, the levels including and to the right of doted line 576 satisfy the criteria 554 for OI, the levels including and to the right of doted line 578 satisfy the criteria 552 for OW, the levels including and to the right of doted line 572 satisfy the criteria 350 for SER, and the levels including and to the left of doted line 574 satisfy the criteria 450 for MCW. Therefore, the set of levels 516 includes the levels that are at and are in between the doted lines 572 and 574, which satisfy the criteria 350, 450, 552, and 554 for OW, SER, MCW, and OI.

The y-axis 520 as depicted in FIGS. 3, 4, and 5 line up with the second level 514, which may not be a value of zero.

### A Level that Satisfies the Criteria for the Parameter

Referring to FIG. 3, the set of levels 316 includes the level at the dotted line 370 and the levels to the right of the dotted line. According to another embodiment, the set of levels may include the levels between the dotted line 370 and the dotted line between the first level 312 and the first measurement 332. According to yet another embodiment, the set of levels may include the level at the dotted line 370, the level at the dotted line between the first level 312 and the first measurement 332 and the levels between those two dotted lines. In still another embodiment, the set of levels may be founded at some other point to the right other than the first level 312. These are just a few examples.

Referring to FIG. 4, the set of levels 416 includes the level at the dotted line 470 and the levels to the left of the dotted line. According to another embodiment, the set of levels may include the levels between the dotted line 470 and the dotted line between the second level 414 and the second measurement 434. According to yet another embodiment, the set of levels may include the level at the dotted line 470, the level at the dotted line between the second level 414 and the second measurement 434 and the levels between those two dotted lines. In still another embodiment, the set of levels may be bound at some other point to the left other than the second level 414. These are just a few examples.

Referring to FIG. 5, the set of levels 516 may include the levels between the dotted lines 572 and 574. According to another embodiment, the set of levels 516 may include the levels at the dotted lines 572 and 574, and the levels between the dotted lines 572 and 574. A set of levels, any subset of the set of levels or any level from the set of levels (referring to description of FIGS. 3, 4, and 5) that satisfy criteria can be determined for an entire disk or for any portion of a disk. For example, various embodiments can be used to determine a level, a set of levels, or any subset of the set of levels. Level(s) can be determined for any disk or any portion of a disk. Levels can be determined for a zone, for each zone, or for one or more head to zone combinations, among other things.

A level or a subset of the set of levels can be determined by adjusting a boundary for a set of levels that satisfy the criteria by a fixed amount. For example, a level that satisfies criteria can be determined by adding 20 mW to the level at the dotted line 370 or by subtracting 20 mW from the level at the dotted line between the first level 312 and the first measurement 332. The dotted line is an example of a boundary. The dotted line between the first level 312 and the first measurement 332 is another example of a potential boundary. A subset of the set of levels 316 can be determined for example by adding a fixed amount, such as 5 mW to the level at the dotted line 370 and by subtracting a fixed amount, such as 5 mW, from the first level 312. The fixed amounts that are added and subtracted do not have to be the same.

One or more levels from a set of levels that satisfies the criteria (FIGS. 3, 4, and 5) can be stored for example in the disk drive. Levels from the set can be stored as a range. The stored level(s) can be used for example during the disk drive's operation to adjust the fly height of the slider to obtain a fly height that provides a tradeoff between reliability and performance.

According to one embodiment, if one or more levels that satisfy the criteria cannot be found, a default level can be used instead. For example, referring to FIG. 3 a set was found that satisfies the SERc. In another example, referring to FIG. 5 a set was found that satisfies the SERc, the MCWc, the OIc, and the OWc. However, in some situations a set will not be found. In this case, a default level can be used. A set can include one level.

User input can be used to configure the disk drive. For example, a user can turn a feature that implements various embodiments on or off. If the feature is on the disk drive may, among other things, use the first measurement and the second measurement to determine if there is the third TFC heater level. If the feature is off, the disk drive may, among other things, use a default value instead of the level that satisfies the criteria. The user can indicate what default level can be used instead of a level that satisfies criteria.

The user can specify how to determine the level. For example, the user can specify that the level is to be calculated based on a fixed amount, such as 20 mW, from a boundary 370. The user can specify the fixed amount. The user can specify which parameter(s) to use. The user can change whatever they specified. The user can specify whether levels are to be used for a particular head or for a particular head to zone combination. The user can specify whether a level, set of levels, or subset of a set of levels will be associated with each head or each head to zone combination. The user could even program the disk drive with a schedule so that at certain times the disk drive automatically uses certain embodiments and other embodiments at other times. These are just a few examples of how user input can be used to determine whether to use a level that satisfies criteria and if so which level. The disk drive may be programmed to perform these tasks automatically rather than being configured with user input. According to one embodiment, level adjustment can be based on internal disk drive temperature for example using TFC temperature slope adjustment.

Measurements for the appropriate parameters can be taken while adjusting a slider's fly height using a level determined using various embodiments. The level can be readjusted based on the measurements. For example, the level may be adjusted to another level from a set that satisfies the criteria or may be adjusted to a default level depending on the measurements. The selected level, the set or the subset of the set, which can be subsequently stored, may be changed based on the new measurements. If an adequate set of measurements cannot be obtained, a default level may be used.

### An Apparatus for Enabling a Tradeoff Between Reliability and Performance for a Disk Drive

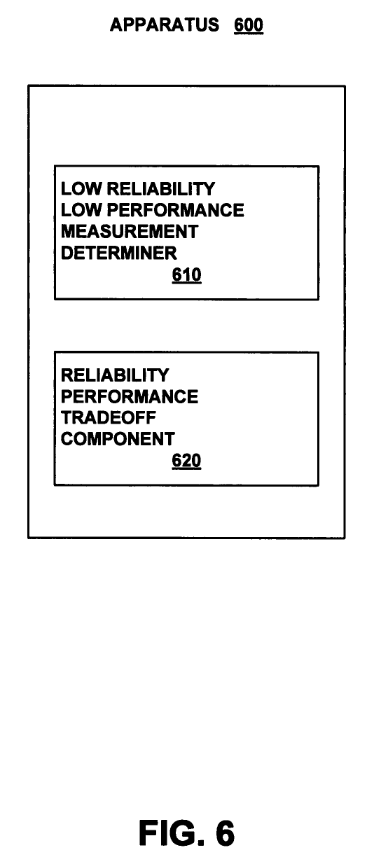

FIG. 6 depicts an apparatus for enabling a tradeoff between reliability and performance for a disk drive, according to one embodiment. The number of pieces of logic represented by the blocks in FIG. 6 may be changed. For example, multiple pieces of logic represented by one block may be separated or pieces of logic represented by two or more blocks may be combined. The pieces of logic represented by the blocks may be implemented with hardware, software, firmware or a combination thereof.

The apparatus 600 can include a low reliability low performance measurement determiner 610 (referred to hereinafter as the “determiner”) and a reliability performance tradeoff component 620 (referred to hereinafter as the “tradeoff component”). The determiner 610 is configured to determine a first measurement at a first TFC heater level that provides low reliability for a parameter and a second measurement at a TFC heater level that provides low performance for the parameter. The tradeoff component 620 is configured to use the first measurement and the second measurement to determine if there is a third TFC heater level that at least satisfies a criteria for the parameter so that the tradeoff between the reliability and the performance for the disk drive is enabled. The apparatus may include a low reliability low performance function determiner for determining a function based on measurements. The apparatus may include a low reliability low performance intersection determiner for determining an intersection based on the function and criteria for the parameter. The tradeoff component 620 can determine a function based on measurements and can determine an intersection based on the function and criteria.

The apparatus 600 can be used, for example, during manufacturing to determine a third TFC heater level or a set of TFC heater levels. The apparatus 600 can be used during the disk drive's operation, for example, during or after the disk drive has been manufactured. The third TFC heater level, the set, or a subset of the set can be associated with the disk drive, for example, by storing level(s) in the disk drive. When the disk drive is used to read or write data, the TFC heater can be heated based on a stored level to provide a tradeoff between reliability and performance.

The apparatus 600 can also be used for multiple parameters as described in the context of FIG. 6. For example, the determiner 610 can determine a first set of measurements at a first TFC heater level that provides low reliability for parameters and a second set of measurements at a second TFC heater level that provides low performance for the parameters. The tradeoff component 620 can determine functions based on the first set of measurements and the second set of measurements associated with the second set for each of the parameters. The tradeoff component 620 can determine intersections based on the functions associated with the corresponding parameters and criteria for the corresponding parameters. The tradeoff component 620 can use the intersections to determine if there is a third set of TFC heater levels that at least satisfies the criteria for the parameters.

### A Method of Enabling a Tradeoff Between Reliability and Performance for a Disk Drive

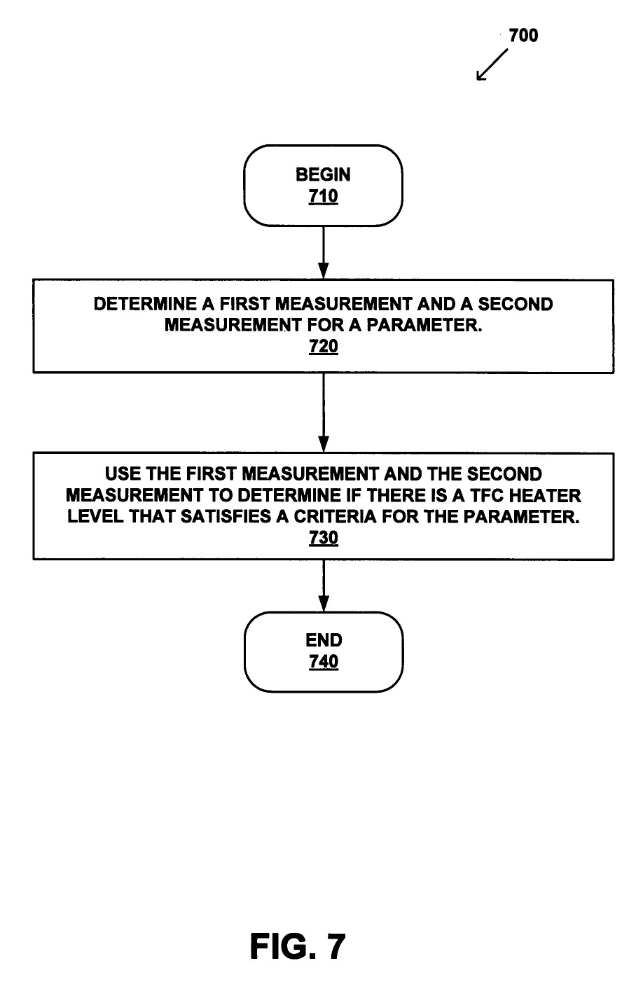

FIG. 7 depicts a flowchart of a method for enabling a tradeoff between reliability and performance for a disk drive, according to one embodiment. Although specific steps are disclosed in flowchart 700, such steps are exemplary. That is, embodiments of the present invention are well suited to performing various other steps or variations of the steps recited in flowchart 700. It is appreciated that the steps in flowchart 700 may be performed in an order different than presented, and that not all of the steps in flowchart 700 may be performed.

The following description of flowchart shall refer to FIGS. 2, 3 and 6.

In step 710, the method begins.

In step 720, a first measurement for a first TFC heater level that provides low reliability for a parameter and a second measurement for a second TFC heater level that provides low performance for the parameter are determined. For example, the determiner 610 can use the TFC heater 214 to cause the head 210 to fly lower and lower until the head 210 touches the disk 220's surface 222. The determiner 610 can use the event of the head 210 touching the disk's surface 222 to determine the first TFC heater level 312, which provides low reliability. However, any TFC heater level that results in low reliability can be used as the first TFC heater level.

The determiner 610 can use the TFC heater 214 to cause the head 210 to fly higher and higher until the SER moves from satisfactory performance to unsatisfactory performance. The determiner 610 can use the fly height that resulted in the satisfactory performance just prior to moving to unsatisfactory performance as the second TFC heater level 314. However, any TFC heater level that results in low performance can be used as the second TFC heater level 314.

The determiner 610 can use the first level 312 and the second level 314 to obtain measurements 332, 334 for the parameter.

In step 730, the first measurement and the second measurement are used to determine if there is a third TFC heater level that at least satisfies a criteria for the parameter whereby the tradeoff between the reliability and the performance for the disk drive is enabled. For example, the tradeoff component 620 can determine a function 340 such as fSER(p) based on the first and second measurements 332, 334 as described for FIG. 3. The tradeoff component 620 can determine an intersection 360 between the criteria 350 (SERc) and the function 340 (fSER(p)). The tradeoff component 620 can determine a third level based on the first measurement 332 and the second measurement 334 where the third level satisfies the SERc. For example, the set of levels 316 that include or are to the right of the intersection 360 between the function 340 (fSER(p)) and the criteria 350 (SERc) satisfy the criteria 350 (SERc). The third level can be any level in the set of levels 316.

In step 740, the method ends.

The third level, the set of levels that satisfies the criteria, or any subset of the set of levels that satisfies the criteria can be stored in the disk drive. Then a level selected from the stored level(s) can be used to adjust the fly height of a slider to provide a tradeoff between reliability and performance, according to one embodiment.

Although the description of flowchart 700 described the determiner 610 determining a first and second level, the determiner 610 can be used to determine more than two levels. Although the description of flowchart 700 referred to a first and second level, more than two levels can be used. For example, the tradeoff component 620 can determine a function fSER(p) based on more than two levels. Although the description of flowchart 700 referred to the SER parameter, other parameters can be used. For example, referring to the description of FIG. 4 for information on determining a third level for a different type of parameter such as MCW. Although the description of flowchart 700 described determining a third level for a single parameter such as SER, various embodiments can be used with multiple parameters as described in the context of FIG. 5. Further, various embodiments can be used to determine a level, a set of levels, or a subset of levels. Level(s) can be determined for any disk or any portion of a disk. Levels can be determined for a zone, for each zone, or for one or more head to zone combinations, among other things.

Various embodiments provide for increased performance with a minimum of reliability risk. For example, experiments showed that various embodiments provided performance or reliability, or a combination thereof, that were close to that provided when using a TFC heater level of approximately 20 mW. Various embodiments provide for a higher manufacturing yield as fewer components need to be thrown away.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments described herein were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A method of enabling a tradeoff between reliability and performance for a disk drive, the method comprising:
determining a first measurement at a first thermal fly height control (TFC) heater level that provides low reliability for a parameter and a second measurement at a second TFC heater level that provides low performance for the parameter; and
using the first measurement and the second measurement to determine if there is a third TFC heater level that at least satisfies a criteria for the parameter whereby the tradeoff between the reliability and the performance for the disk drive is enabled.

2. The method as recited by claim 1, wherein the parameter is a first parameter and wherein the method further comprises:
determining measurements for a second parameter;
using the measurements for the second parameter to determine if there is a fourth TFC heater level that at least satisfies a criteria for the second parameter; and
if the fourth TFC heater level exists, determining if there is a set of levels that satisfy the criteria for the first parameter and that satisfy the criteria for the second parameter.

3. The method as recited by claim 1, further comprising:
storing the third TFC heater level in the disk drive; and
accessing the stored TFC heater level to adjust a fly height of a slider associated with the disk drive.

4. The method as recited by claim 1, further comprising:
determining the first measurement at the first thermal fly height control (TFC) heater level that provides the low reliability for the parameter and the second measurement at the second TFC heater level that provides the low performance for the parameter, wherein the parameter is selected from a group consisting of soft error rate (SER), old information (OI), over write (OW), and magnetic core width (MCW).

5. The method as recited by claim 1, wherein the second TFC heater level provides satisfactory performance and is in proximity to a TFC heater level that provides unsatisfactory performance.

6. The method as recited by claim 1, wherein the first TFC heater level is in proximity to a TFC heater level that provides unsatisfactory reliability.

7. An apparatus for enabling a tradeoff between reliability and performance for a disk drive, the apparatus comprising:
a low reliability low performance measurement determiner configured for determining a first measurement at a first thermal fly height control (TFC) heater level that provides low reliability for a parameter and a second measurement at a second TFC heater level that provides low performance for the parameter; and
a reliability performance tradeoff component configured for using the first measurement and the second measurement to determine if there is a third TFC heater level that at least satisfies a criteria for the parameter whereby the tradeoff between the reliability and the performance for the disk drive is enabled.

8. The apparatus of claim 7, further comprising:
a low reliability low performance function determiner configured for determining a function based on the first measurement and the second measurement for the parameter.

9. The apparatus of claim 8, further comprising:
a low reliability low performance intersection determiner configured for determining an intersection based on the function and criteria for the parameter.

10. The apparatus of claim 9, wherein the reliability performance tradeoff component is configured for using the intersection to determine if there is a third TFC heater level that at least satisfies the criteria for the parameter whereby the tradeoff between the reliability and the performance for the disk drive is enabled.

11. The apparatus of claim 7, wherein the parameter is selected from a group consisting of soft error rate (SER), old information (OI), over write (OW), and magnetic core width (MCW).

12. The apparatus of claim 7, wherein:
the low reliability low performance measurement determiner is configured for determining a third measurement at a fourth thermal fly height control (TFC) heater level that provides low reliability for a second parameter and a fourth measurement at a fifth TFC heater level that provides low performance for the second parameter;
the reliability performance tradeoff component is configured for using the measurements for the second parameter to determine if there is a sixth TFC heater level that at least satisfies a criteria for the second parameter; and
if the sixth TFC heater level exists, the reliability performance tradeoff component is configured for determining if there is a set of levels that satisfy the criteria for the first parameter and that satisfy the criteria for the second parameter.

13. The apparatus of claim 13, wherein the first TFC heater level and the fourth TFC heater level are the same level and wherein the second TFC heater level and the fifth TFC heater level are the same level.

14. The apparatus of claim 7, wherein the second TFC heater level provides satisfactory performance and is in proximity to a TFC heater level that provides unsatisfactory performance.

15. The apparatus of claim 7, wherein the first TFC heater level is in proximity to a TFC heater level that provides unsatisfactory reliability.

16. The apparatus of claim 7, wherein the third TFC heater level is determined by adjusting a boundary of a set of levels that satisfy the criteria by a fixed amount.

17. The apparatus of claim 7, wherein the disk drive receives user input which configures the disk drive to use the first measurement and the second measurement to determine if there is the third TFC heater level.

18. The apparatus of claim 7, wherein the disk drive receives user input indicating how to determine the third TFC heater level.

19. An apparatus for enabling a tradeoff between reliability and performance for a disk drive, the apparatus comprising:
means for determining a first measurement at a first thermal fly height control (TFC) heater level that provides low reliability for a parameter and a second measurement at a second TFC heater level that provides low performance for the parameter;
means for determining a function based on the first measurement and the second measurement for the parameter;
means for determining an intersection based on the function and criteria for the parameter; and
means for using the intersection to determine if there is a third TFC heater level that at least satisfies the criteria for the parameter whereby the tradeoff between the reliability and the performance for the disk drive is enabled.

20. The apparatus of claim 18, further comprising:
means for determining a third measurement at a fourth thermal fly height control (TFC) heater level that provides low reliability for a parameter and a fourth measurement at a fifth TFC heater level that provides low performance for the parameter;
means for using the measurements for the second parameter to determine if there is a sixth TFC heater level that at least satisfies a criteria for the second parameter; and
if the sixth TFC heater level exists, means for determining if there is a set of levels that satisfy the criteria for the first parameter and that satisfy the criteria for the second parameter.

21. The apparatus of claim 19, further comprising means for receiving user input indicating whether and how to determine the third TFC heater level.
